(19) United States
(12) Patent Application Publication
(10) Pub. No.: US 2014/0098123 A1
(43) Pub. Date: Apr. 10, 2014

(54) Graphical User Interface for Visualizing the Severity of Time Intervals and Events

(71) Applicant: International Business Machines Corporation, Armonk, NY (US)

(72) Inventors: Gregory L. Daynes, Fishkill, NY (US); Rolando Perez, Poughkeepsie, NY (US); Christopher A. Robbins, Monroe Township, NJ (US)

(73) Assignee: International Business Machines Corporation, Armonk, NY (US)

(21) Appl. No.: 14/101,530

(22) Filed: Dec. 10, 2013

Related U.S. Application Data
(63) Continuation of application No. 13/447,395, filed on Apr. 16, 2012.

(51) Int. Cl. G06T 11/20; G09G 5/02

(52) U.S. Cl. CPC G06T 11/206; G09G 5/02
USPC 345/589

(57) ABSTRACT

A method for displaying a timeline includes receiving, by a processor, a plurality of events and a plurality of time intervals, wherein each of the plurality of events and each of the plurality of time intervals include an associated importance level and determining one or more time periods that correspond to each of the plurality of time intervals. The method also includes displaying the time periods, wherein a color of a background of each time period is based upon the time interval that the time period corresponds to and indicates the associated importance level of the time interval. The method further includes displaying an icon for each of the plurality of events, wherein the icon is indicative of the associated importance level of the event and wherein each icon is disposed in the time period that corresponds to a date of the event.

### CROSS-REFERENCE TO RELATED APPLICATION

This application is a continuation application of the legally related U.S. Ser. No. 13/447,395; filed Apr. 16, 2012, the contents of which are incorporated by reference herein in their entirety.

### BACKGROUND

The present invention relates to graphical user interfaces, and more specifically, to a graphical user interface for visualizing the severity of time intervals and events.

In general, graphical user interfaces (GUIs) are commonly used to graphically depict information to users in a way that is easily and quickly understandable by the user. Currently, a number of graphical user interface solutions are available that display timelines for the purpose of identifying when events have occurred or are scheduled to occur. These timelines are commonly used in GUIs for exploring historical events and for applications such as editing audio and video.

In many applications, a user may be interested in information regarding periods of time in addition to information regarding specific events. In some instances, a user may want to associate an importance level with a period of time in addition a specific event. For example, a user may want to indicate that a specific period of time before or after an event as important or critical.

While currently available GUIs are suitable for their intended purposes, existing GUIs do not address the need to express information regarding time periods in addition to events.

### SUMMARY

According to an exemplary embodiment, a method for displaying a timeline includes receiving, by a processor, a plurality of events and a plurality of time intervals, wherein each of the plurality of events and each of the plurality of time intervals include an associated importance level and determining one or more time periods that correspond to each of the plurality of time intervals. The method also includes displaying the time periods, wherein a color of a background of each time period is based upon the time interval that the time period corresponds to and indicative of the associated importance level of the time interval. The method further includes displaying an icon for each of the plurality of events, wherein the icon is indicative of the associated importance level of the event and wherein each icon is disposed in the time period that corresponds to a date of the event.

According to another exemplary embodiment, a computer program product for displaying a timeline is provided. The computer program product includes a tangible storage medium readable by a processing circuit and storing instructions for execution by the processing circuit for performing a method. The method includes receiving, by a CPU, a plurality of events and a plurality of time intervals, wherein each of the plurality of events and each of the plurality of time intervals include an associated importance level and determining one or more time periods that correspond to each of the plurality of time intervals. The method also includes displaying the time periods, wherein a color of a background of each time period is based upon the time interval that the time period corresponds to and indicative of the associated importance level of the time interval. The method further includes displaying an icon for each of the plurality of events, wherein the icon is indicative of the associated importance level of the event and wherein each icon is disposed in the time period that corresponds to a date of the event.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram illustrating one example of a processing system for practice of the teachings herein;

FIG. 2 is a graphical user interface illustrating a timeline for visualizing the severity of time intervals and events in accordance with an exemplary embodiment;

FIG. 3 is a graphical user interface illustrating a timeline for visualizing the severity of time intervals and events in accordance with a further exemplary embodiment;

FIG. 4 is a graphical user interface illustrating a timeline for visualizing the severity of time intervals and events in accordance with another exemplary embodiment;

FIG. 5 is a graphical user interface illustrating a timeline and tabular display for visualizing the severity of time intervals and events in accordance with another exemplary embodiment; and

FIG. 6 is a flow diagram that illustrates a method for creating graphical user interface for visualizing the severity of time intervals and events in accordance with an exemplary embodiment is shown.

### DETAILED DESCRIPTION

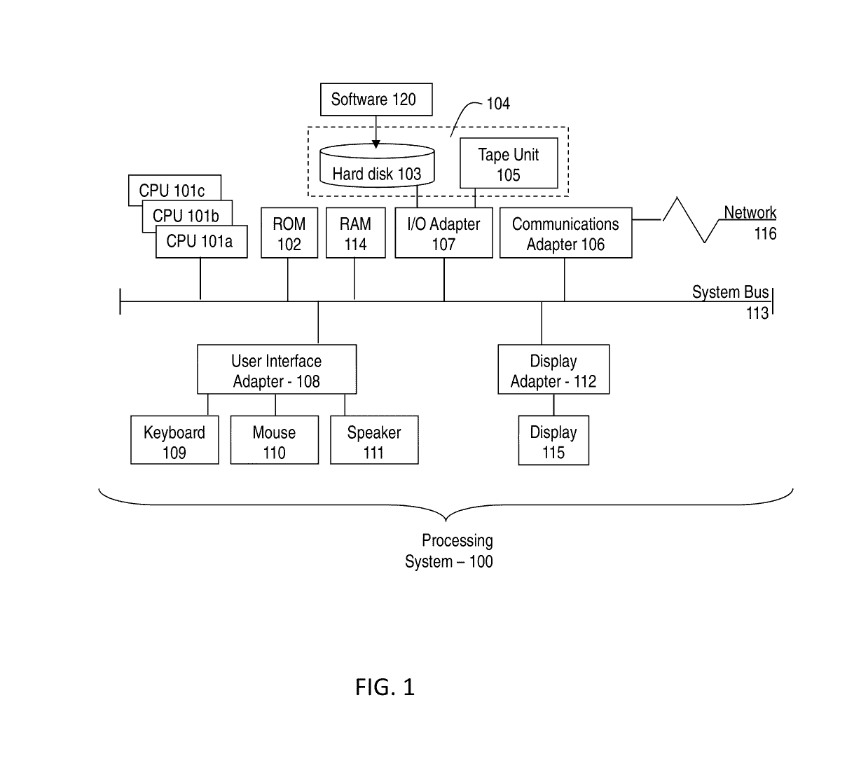

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

Examples of operating systems that may be supported by the system 100 include Windows 95, Windows 98, Windows NT 4.0, Windows XP, Windows 2000, Windows CE, Windows Vista, Macintosh, Java, LINUX, and UNIX, or any other suitable operating system. The system 100 also includes a network interface 116 for communicating over a network. The network can be a local-area network (LAN), a metro-area network (MAN), or wide-area network (WAN), such as the Internet or World Wide Web. Users of the system 100 can connect to the network through any suitable network interface 116 connection, such as standard telephone lines, digital subscriber line, LAN or WAN links (e.g., T1, T3), broadband connections (Frame Relay, ATM), and wireless connections (e.g., 802.11a, 802.11b, 802.11g).

As disclosed herein, the system 100 includes machine readable instructions stored on machine readable media (for example, the hard disk 104) for capture and interactive display of information shown on the screen 115 of a user. As discussed herein, the instructions are referred to as “software” 120. The software 120 may be produced using software development tools as are known in the art. Also discussed herein, the software 120 may also referred to as a “command line testing tool” 120, an “a testing interface” 120 or by other similar terms. The software 120 may include various tools and features for providing user interaction capabilities as are known in the art.

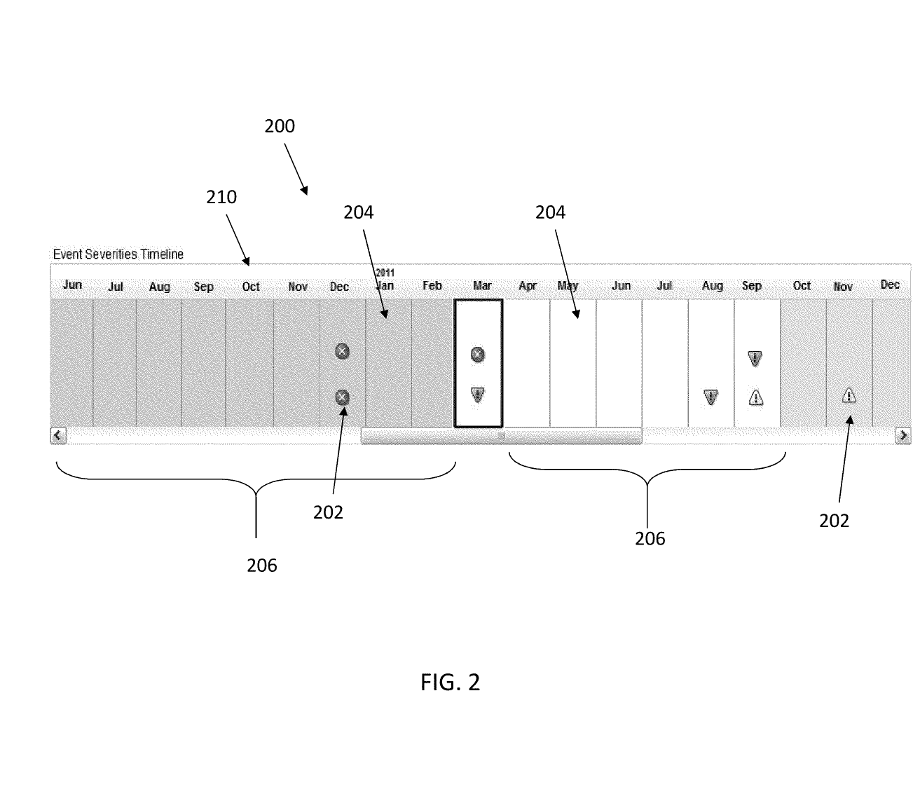

Referring now to FIG. 2, a GUI 200 illustrating a timeline 210 for visualizing the severity of time intervals and events in accordance with an exemplary embodiment is shown. The timeline 210 includes one or more events 202, which can each be represented by an icon. As illustrated, the icons representing the events 202 may have various shapes and/or colors which can be selected to be indicative of the severity or importance of the represented event. In exemplary embodiments, the icons representing the events 202 can be used to indicate that the event is critical, important, major, minor, or the like. In addition, the timeline 210 includes one or more time periods 204 that have a background that is shaded or colored to indicate an importance or severity level assigned to the time period 204. In exemplary embodiments, one or more adjacent time periods 204 may be grouped into a time interval 206. The color or shading of the background of the time period 204 can be used to indicate that the associated time interval 206 is critical, important, major, minor, or the like. In exemplary embodiments, the GUI 200 provides a user with an immediate conveyance of the severity of given time intervals 206 and events 202 in the timeline 210.

In an exemplary embodiment, the timeline 210 depicted in the GUI 200 may be divided into monthly time periods 204, which are combined to form time intervals 206. Although the time periods 204 depicted are shown as months, it will be understood by those of ordinary skill in the art that the time period 204 may be any suitable time period 204 including, but not limited to, days, weeks, months, years or the like. The severity or importance of each time interval 206 can be indicated by the background color of the time periods 204 that correspond to each time interval 206. For example, a red background color may be used to indicate a critically important time period, an orange background color may be used to indicate a time period with major importance and a yellow background color may be used to indicate a time period with minor importance. In addition, the timeline 210 includes several events 202 that are each represented by an icon, the events 202 are located in the time period 204 during which the event occurred or is scheduled to occur. In exemplary embodiments, the icon used for each event 202 can be selected to be indicative of the severity or importance of the event. For example, a red icon may be used to indicate a critical event, an orange icon may be used to indicate an event with major importance and a yellow icon may be used to indicate an event with minor importance.

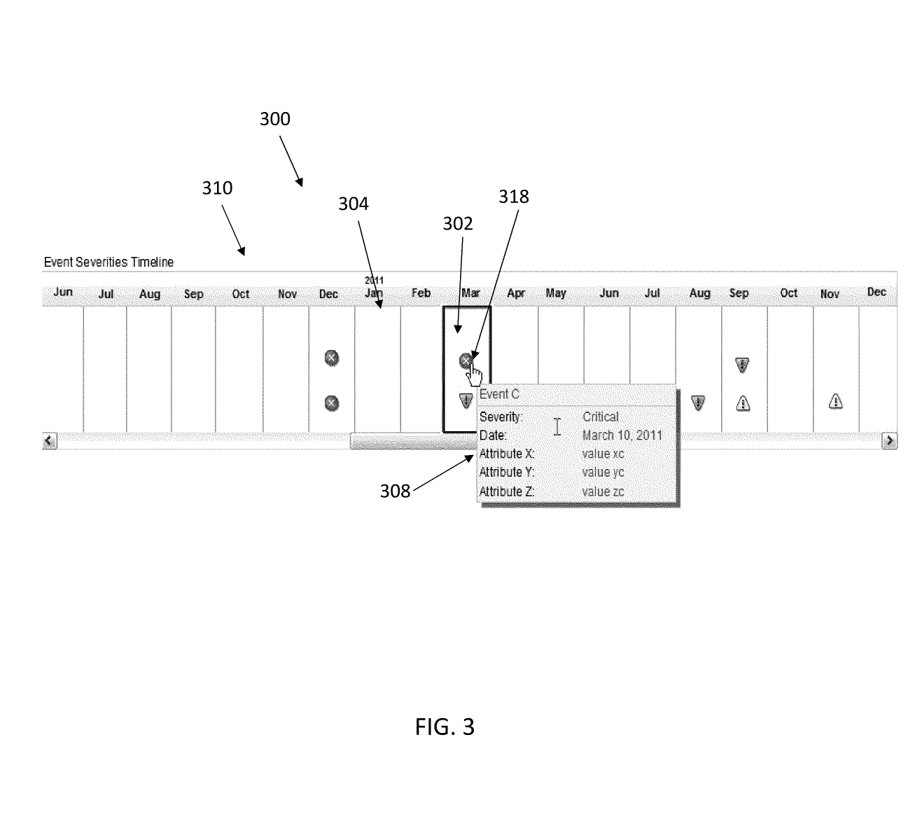

Referring now to FIG. 3, a GUI 300 illustrating a timeline 310 for visualizing the severity of time intervals and events in accordance with an exemplary embodiment is shown. In exemplary embodiments, the GUI 300 provides a user with access to details 308 associated with an event 302. In one embodiment, the GUI 300 may be configured to display the details 308 of an event 302 when a user places a cursor 318 over the icon representing an event 302. In another embodiment, the GUI 300 may be configured to only display the details 308 associated with an event 302 when a user places and keeps a cursor 318 over the icon representing an event 302 for a predetermined period of time. In yet another embodiment, the GUI 300 may be configured to only display the details 308 associated with an event 302 when a user places a cursor 318 over the icon representing an event 302 and clicks, right clicks, or double clicks on the icon.

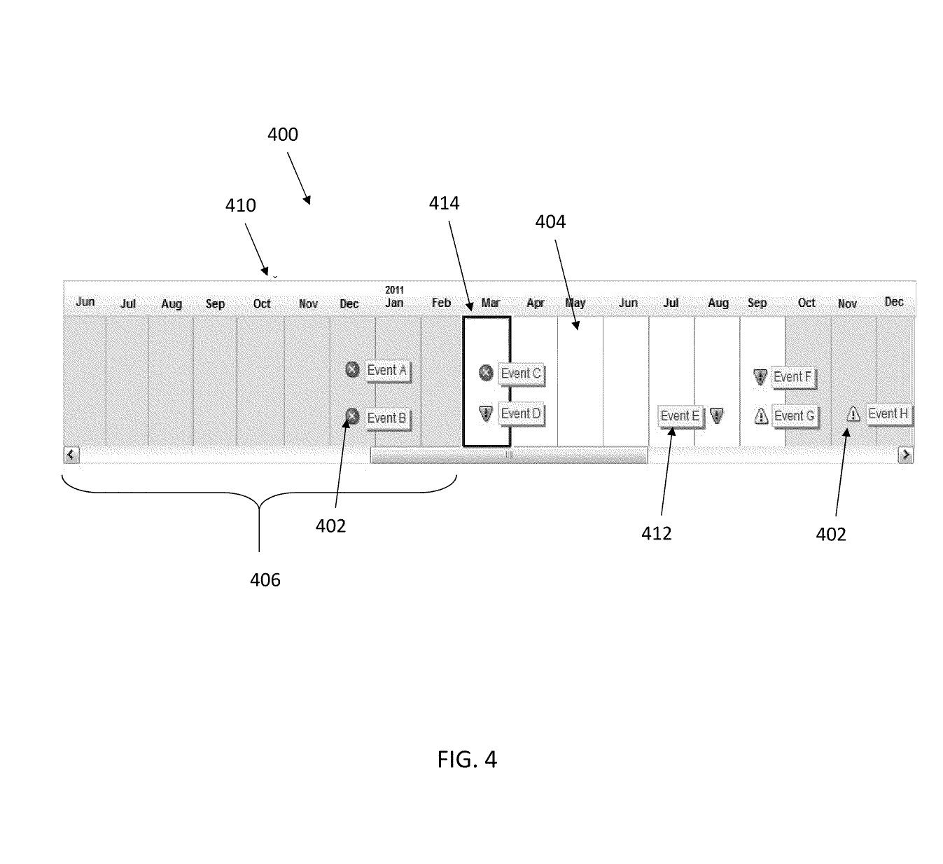

Referring now to FIG. 4, a GUI 400 illustrating a timeline 410 for visualizing the severity of time intervals and events in accordance with an exemplary embodiment is shown. In exemplary embodiments, the GUI 400 may include a menu item or button (not shown) that can be used to control a display mode of the GUI 400. In exemplary embodiments, the display mode may include an option to display a short label 412 for each of the events 402 adjacent to the icon representing the event 402. In addition, the display mode may include an option for selectively displaying events that have specified levels of severity or importance. For example, the display mode options may allow a user to only display critically or majorly important events 402. In exemplary embodiments, one of the time periods 404 may be marked as a current time period 414. For example, the current time period 414 can be indicated by shading the background color of the current time period in a different color, by placing a border around the current time period 414, or various other methods.

In exemplary embodiments, the a GUI 400 for illustrating a timeline 410 can be configured to automatically update the importance level associated with an event 402 and a time interval 406 based on changes in the current time period 414. For example, an event 402 may be configured to have a minor importance if the event is more than 90 days from the current time period 414, a major importance if the event is less than 90 days from the current time period 414 and more than 30 days from the current time period 414, or a critical importance if the event date is less than 5 days from the current time period 414. Likewise, a background color of the time periods 404 in each time interval 406 can be automatically changed based on changes in the current time period 414.

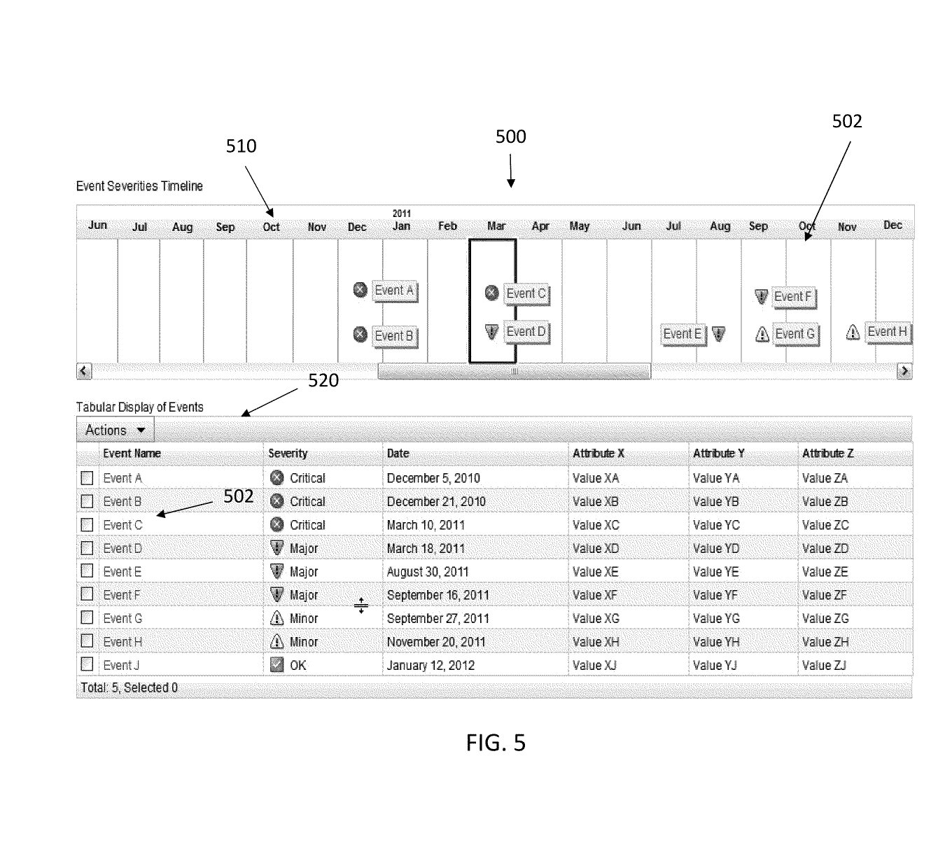

Referring now to FIG. 5, a GUI 500 illustrating a timeline 510 and a tabular display 520 for visualizing the severity of time intervals and events in accordance with an exemplary embodiment is shown. In one embodiment, the tabular display 520 may be a summary table that includes the information provided by the timeline 510. In another embodiment, the tabular display 520 can provide additional features for filtering, sorting, and searching through the events 502 contained in the timeline 510. In exemplary embodiments, the GUI 500 may include a menu item or button (not shown) that can be used to control a display mode of the GUI 500. In exemplary embodiments, the display mode may include an option to display or hide the tabular display 520. In addition, the display mode may include an option for selecting which details corresponding to events 502 are illustrated in the tabular display 520. In exemplary embodiments, the tabular display 520 includes a listing of events 502 that can be easily sorted, searched and filtered.

A timeline for visualizing the severity of time periods and events may be used in connection with various applications. In one example, the timeline for visualizing the severity of time periods and events can be used in connection with managing one or more software licenses or software maintenance agreements. For example, a typical software maintenance agreement or license may include various time intervals and events that could be displayed in the timeline. In one example, an event may include a termination date of the license or a date upon with a software vendor will no longer support a particular version of the software and the time interval may include a specific period of time either before or after the event that is of interest to the user. If the event is an date that a vendor will no longer be supporting a piece of software, various time intervals before this event may be desired by the user and may include increasing severity as the event approaches. If the event is the expiration date of a license, various time intervals either before or after the expiration date may be of interest to the user such as a renewal, notice or grace period that are provided for in the license agreement.

In another example, the timeline for visualizing the severity of time periods and events can be used in connection with project management or planning For example, in project management applications there are a variety of events and time intervals that each has an associated importance level, or severities, which can be illustrated by the timeline such that a user is able to immediately view and understand the timeline.

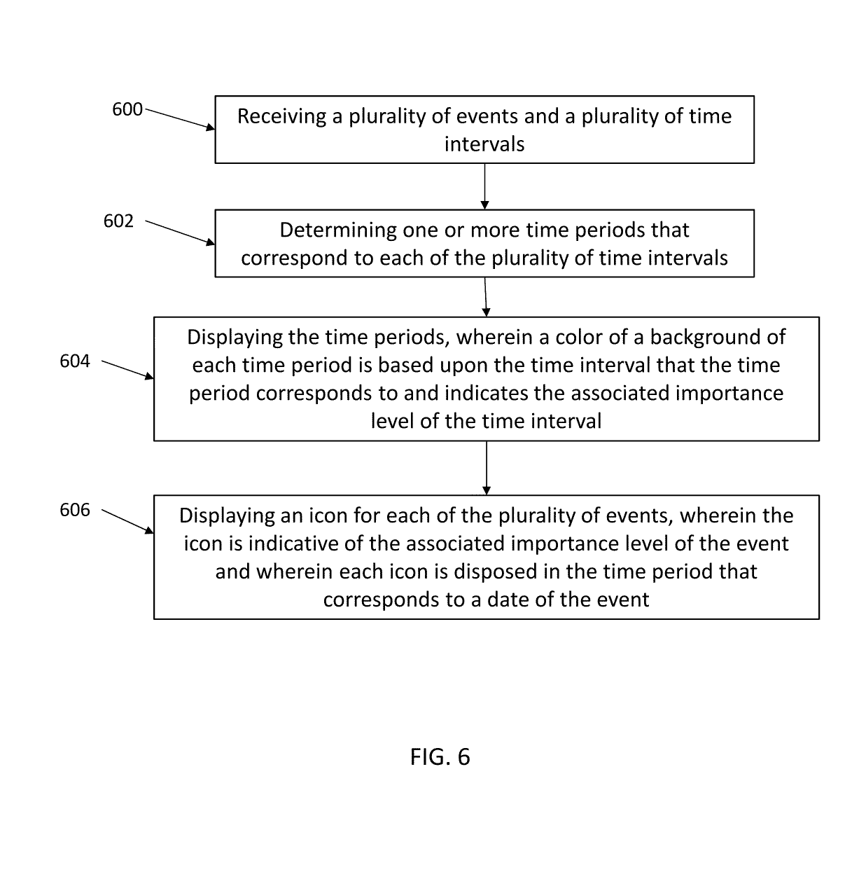

Referring now to FIG. 6, a flow diagram that illustrates a method for creating graphical user interface for visualizing the severity of time intervals and events in accordance with an exemplary embodiment is shown. As shown at block 600, the method includes receiving a plurality of events and a plurality of time intervals. Next, as shown at block 602, the method determines one or more time periods that correspond to each of the plurality of time intervals. At block 604, the method includes displaying the time periods, wherein a color of a background of each time period is based upon the time interval that the time period corresponds to and indicates the associated importance level of the time interval. Next, as shown at block 606, the method includes displaying an icon for each of the plurality of events, wherein the icon is indicative of the associated importance level of the event and wherein each icon is disposed in the time period that corresponds to a date of the event.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for displaying a timeline, comprising:
receiving, by a processor, a plurality of events and a plurality of time intervals, wherein each of the plurality of events and each of the plurality of time intervals include an associated importance level;
determining one or more time periods that correspond to each of the plurality of time intervals;
displaying the time periods, wherein a color of a background of each time period is based upon the time interval that the time period corresponds to and indicates the associated importance level of the time interval;
displaying an icon for each of the plurality of events, wherein the icon is indicative of the associated importance level of the event and wherein each icon is disposed in the time period that corresponds to a date of the event.

2. The method of claim 1, further comprising:
displaying a tabular display which contains a plurality of details associated with each event.

3. The method of claim 2, wherein the tabular display is configured for filtering, sorting, and searching by a user.

4. The method of claim 1, wherein the associated importance level of each event is based on a time difference between the current time period and the event.

5. The method of claim 1, further comprising;
displaying one or more details associated with one of the plurality of events in response to a user action.

6. The method of claim 5, wherein the user action is placing a cursor above the icon representing the event.

7. A computer program product for displaying a timeline, the computer program product comprising:
a tangible storage medium readable by a processing circuit and storing instructions for execution by the processing circuit for performing a method, comprising:
receiving a plurality of events and a plurality of time intervals, wherein each of the plurality of events and each of the plurality of time intervals include an associated importance level;
determining one or more time periods that correspond to each of the plurality of time intervals;
displaying the time periods, wherein a color of a background of each time period is based upon the time interval that the time period corresponds to and indicates the associated importance level of the time interval;
displaying an icon for each of the plurality of events, wherein the icon is indicative of the associated importance level of the event and wherein each icon is disposed in the time period that corresponds to a date of the event.

8. The computer program product of claim 7, further comprising:
displaying a tabular display which contains a plurality of details associated with each event.

9. The computer program product of claim 8, wherein the tabular display is configured for filtering, sorting, and searching by a user.

10. The computer program product of claim 7, wherein the associated importance level of each event is based on a time difference between the current time period and the event.

11. The computer program product of claim 7, further comprising;
displaying one or more details associated with one of the plurality of events in response to a user action.

12. The computer program product of claim 11, wherein the user action is placing a cursor above the icon representing the event.
